(19) United States
(12) Patent Application Publication
(10) Pub. No.: US 2026/0287454 A1
(43) Pub. Date: Sep. 24, 2026

(54) SENSOR FOR MEASURING A PRESSURE AND PROCESS FOR MANUFACTURING SAID SENSOR

(71) Applicant: Kistler Holding AG, Winterthur (CH)

(72) Inventors: Christian HEER, Winterthur (CH); Micha MOOSHEER, Niederhelfenschwil (CH); Joerg GRAMICH, Illnau (CH)

(21) Appl. No.: 19/571,583

(22) Filed: Mar. 19, 2026

(30) Foreign Application Priority Data
Mar. 24, 2025 (EP) 25165557.7

(51) Int. Cl. G01L 9/00; G01L 19/14

(52) U.S. Cl. CPC G01L 9/0052; G01L 19/143

(57) ABSTRACT

A sensor for measuring a pressure has an inner housing part, a diaphragm element, a measuring unit, and a feedthrough. The inner housing part and diaphragm element are hollow-cylindrical in shape and enclose a cavity. The inner housing part is delimited in an axial direction by a first housing end and a second housing end, and delimited in a radial direction by a housing wall. The diaphragm element is secured to the first housing end, and the feedthrough is secured to the second housing end and closes up the cavity. The measuring unit is arranged within the cavity, operates per the piezoresistive measuring principle and is designed to generate at least one measurement signal under the effect of the introduced pressure. The feedthrough conducts the measurement signal from the cavity to the outside of the inner housing part.

### TECHNICAL FIELD

The invention relates to a sensor for measuring a pressure and a process for manufacturing said sensor, which includes a feedthrough electrically connected to a measuring unit disposed in a hollow cavity defined inside a wall of a protective inner housing part.

### BACKGROUND OF THE INVENTION

Sensors for measuring the pressure of a medium are well-known. For example, WO2008/025182A2, which corresponds to US Patent Application Publication No. 2010-0018494 that is hereby incorporated herein in its entirety by this reference for all purposes, describes a sensor for measuring the pressure of a medium. The sensor comprises a sensor housing and a measuring unit. The sensor housing is cylindrical in shape and encloses a cavity. The measuring unit is arranged within the cavity. The sensor housing comprises a measurement opening through which the medium enters the cavity to the measuring unit. For the protection against the medium, said measuring unit is separated from the medium by a cover layer. The pressure of the medium acts on the measuring unit via said cover layer. Under the effect of the pressure, the measuring unit generates a measurement signal. Said measuring unit is a SOI (silicon-on-insulator) chip that operates according to the piezoresistive measuring principle. An example is disclosed in US Patent No. 4,993,266, which is hereby incorporated herein in its entirety by this reference for all purposes. The measuring unit comprises a thin planar supporting element. Electrical resistance elements and electrical conductor elements are arranged on a side of the supporting element facing the cover layer. Plated-through holes extend through the supporting element. On a side of the supporting element facing away from the cover layer, said plated-through hole is electrically connected to supply lines in the cavity. The measurement signal is tapped through the plated-through holes and the supply lines, and an operating voltage is supplied to the measuring unit for the operation thereof.

However, as sensors become more miniaturized, so too do the electrical contact points of some of the sensor’s components, while the electrical contact points of other components do not necessarily conform in their sizing to that of their miniaturized neighbors. Moreover, the need to reduce cost structures by adapting the manufacture of the miniaturized sensor to robotic techniques, poses additional complications when robots must electrically connect different components of the sensor.

### OBJECTS AND SUMMARY OF THE INVENTION

A first object of the present invention is to simplify the design of the sensor known from WO2008/025182A2 for measuring a pressure. It is a further object of the present invention to demonstrate a cost-effective process for manufacturing said sensor.

These objects have been achieved by the features described below.

The invention relates to a sensor for measuring a pressure. The sensor includes an inner housing part, a diaphragm element, a measuring unit and a feedthrough. The inner housing part and the diaphragm element are hollow cylindrical in shape, elongate about a longitudinal axis and enclose a cavity. The inner housing part is bounded in the longitudinal axial direction by a first housing end and a second housing end disposed spaced apart along the longitudinal axis from the first housing end. The inner housing part is bounded in a radial direction with respect to the longitudinal axial direction by a housing wall that defines a pair of radial openings providing access to the cavity from outside the inner housing part. The diaphragm element is attached to the first housing end. The cavity extends through an axial opening at the first housing end in the longitudinal direction from the inner housing part to the diaphragm element. The feedthrough is attached to the second housing end and closes up the cavity at the second housing end. The diaphragm element is configured and disposed to conduct the pressure to be measured into the cavity. The measuring unit is arranged in the cavity and configured and disposed to be actuated by flexing of the diaphragm in the direction of the longitudinal axis X. The measuring unit operates according to the piezoresistive measuring principle and is configured to generate at least one measurement signal under the effect of the introduced pressure. The feedthrough is configured and disposed to conduct the measurement signal from the cavity to the outside of the inner housing part. The measuring unit includes a supporting body, a first measuring circuit, and a second measuring circuit. A tapping unit includes a contact body that is a solid cuboid made of electrically insulating material and defines a first contact surface disposed spaced apart from and parallel to a second contact surface. The first contact surface defines a first contact surface normal, and the second contact surface defines a second contact surface normal that is disposed at an angle greater than zero with respect to an angle of disposition of the first contact surface normal. A plurality of conductor elements are configured and disposed to electrically connect the measuring unit to the feedthrough via the first and second contact surfaces.

The invention also relates to a process for manufacturing a sensor for measuring a pressure, wherein the sensor is configured generally as described above and includes an inner housing part enclosing a hollow cavity, a diaphragm element, a measuring unit, a tapping unit, a plurality of conductor elements and a feedthrough. Each of these components is provided and made available during an appropriate sequence of the process of manufacturing the sensor, which process is broadly described as follows. The diaphragm element is attached to the first housing end so that the cavity extends from the inner housing part to the diaphragm element through an axial opening at the first housing end The feedthrough is attached to the second housing end and closes up the cavity at the second end of the inner housing part. The measuring unit is arranged in the cavity so as to generate at least one measurement signal under the effect of the introduced pressure. The measuring unit and the tapping unit are pushed into the cavity in the longitudinal direction through the axial opening at the first housing end. The diaphragm element is attached to the first housing end. The measuring unit is electrically connected with the feedthrough via a first and second contact surface of the tapping unit by means of the conductor elements.

Advantageous embodiments of the invention are described below with greater elaboration on more of their particulars.

### BRIEF DESCRIPTION OF THE DRAWINGS

The invention will now be explained in more detail with reference to two exemplary embodiments and the accompanying figures, in which:

FIG. 1 shows a perspective view of a part of a first embodiment of a sensor 10 comprising a measuring unit 3, a tapping unit 5, and a feedthrough 4 for measuring a pressure P;

FIG. 2 shows a perspective view of a part of a second embodiment of a sensor 10 comprising a measuring unit 3, a tapping unit 5, and a feedthrough 4 for measuring a pressure P;

FIG. 3 shows a section through a part of the first embodiment of the sensor 10 according to FIG. 1 in a representation in a vertical plane XZ;

FIG. 4 shows a section through a part of the second embodiment of the sensor 10 according to FIG. 2 in a representation in the vertical plane XZ;

FIG. 5 shows an enlarged schematic representation of a part of a first measuring device 3.2 of the measuring unit 3 of the sensor 10 of the two embodiments as shown in FIGS. 1 to 4 in a representation in a transverse plane XY;

FIG. 6 shows an enlarged schematic representation of a part of a second measuring device 3.3 of the measuring unit 3 of the sensor 10 of the two embodiments as shown in FIGS. 1 to 4 in a representation in the transverse plane XY;

FIG. 7 shows an enlarged view of a part of a first embodiment of the tapping unit 5 of the sensor 10 of the first embodiment as shown in FIGS. 1 and 3 in a representation in a perspective view in the transverse plane XY;.

FIG. 8 shows an enlarged view of a part of a second embodiment of the tapping unit 5 of the sensor 10 of the second embodiment as shown in FIGS. 2 and 4 in a representation in a perspective view in the transverse plane XY;

FIG. 9 shows a schematic representation of the electrical circuitry of the first embodiment of the sensor 10 according to FIG. 1 with the first embodiment of the tapping unit 5 according to FIG. 7;

FIG. 10 shows a schematic representation of the electrical circuitry of the second embodiment of the sensor 10 according to FIG. 2 with the second embodiment of the tapping unit 5 according to FIG. 8;

FIG. 11 shows a section through an outer housing part 7 of the sensor 10 of the two embodiments as shown in FIGS. 1 to 4 in a representation in the transverse plane XY;

FIG. 12 shows an exploded disassembled cross-sectional view of a section of the sensor 10 of the first embodiment as shown in FIGS. 1 and 3 comprising an inner housing part 1, a diaphragm element 2, the measuring unit 3, the first embodiment of the tapping unit 5 according to FIG. 7, the feedthrough 4, and a transmission element 6 in a representation in the transverse plane XY;

FIG. 13 shows a section through a part of the sensor 10 according to FIG. 12 with the outer housing part 7 according to FIG. 11 after manufacturing in a representation in the vertical plane XZ;

FIG. 14 shows an exploded disassembled cross-sectional view of a section of the sensor 10 of the second embodiment as shown in FIGS. 2 and 4 comprising an inner housing part 1, a diaphragm element 2, the measuring unit 3, the second embodiment of the tapping unit 5 according to FIG. 8, the feedthrough 4, and a transmission element 6 in a representation in the transverse plane XY; and

FIG. 15 shows a section through a part of the sensor 10 according to FIG. 14 with the outer housing part 7 according to FIG. 11 after manufacturing in a representation in the vertical plane XZ.

Throughout the figures, identical reference numerals denote identical objects in the figures.

### DETAILED DESCRIPTION OF EXEMPLARY EMBODIMENTS OF THE INVENTION

The sensor 10 comprises an inner housing part 1, a diaphragm element 2, a measuring unit 3, a feedthrough 4, a tapping unit 5, a transmission element 6, an outer housing part 7, and a cable 8.

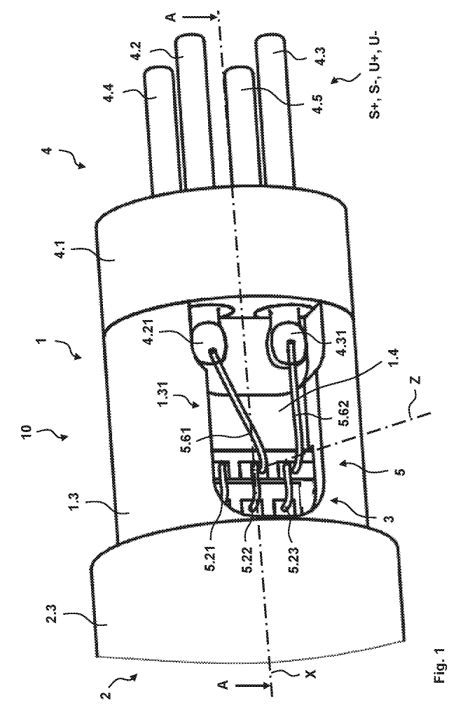

FIGS. 1 to 8 and 11 to 15 show parts of two exemplary embodiments of said sensor 10 according to the invention for measuring a pressure P. Said sensor 10 is shown in a three-dimensional coordinate system. The coordinate system comprises three axes. The three axes X, Y, Z are perpendicular to each other. Two of the axes X, Y, Z each span a plane XY, XZ, YZ. The three axes X, Y, Z are also referred to as the longitudinal axis X, transverse axis Y, and vertical axis Z. The longitudinal axis X and the transverse axis Y span a transverse plane XY. The longitudinal axis X and the vertical axis Z form a vertical plane XZ. The transverse axis Y and the vertical axis Z form a normal plane YZ. In the following, a direction parallel to the longitudinal axis X is also referred to as the longitudinal direction, while a direction perpendicular to it is referred to as the radial direction.

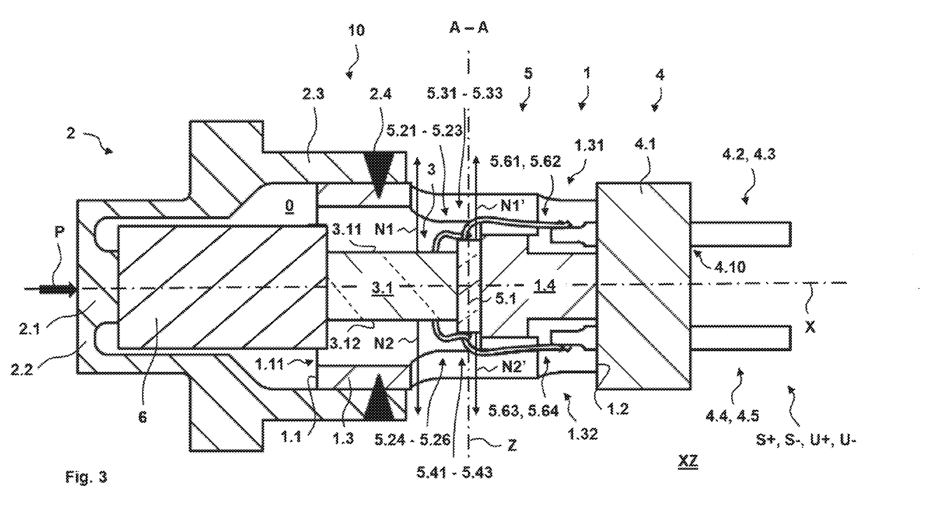

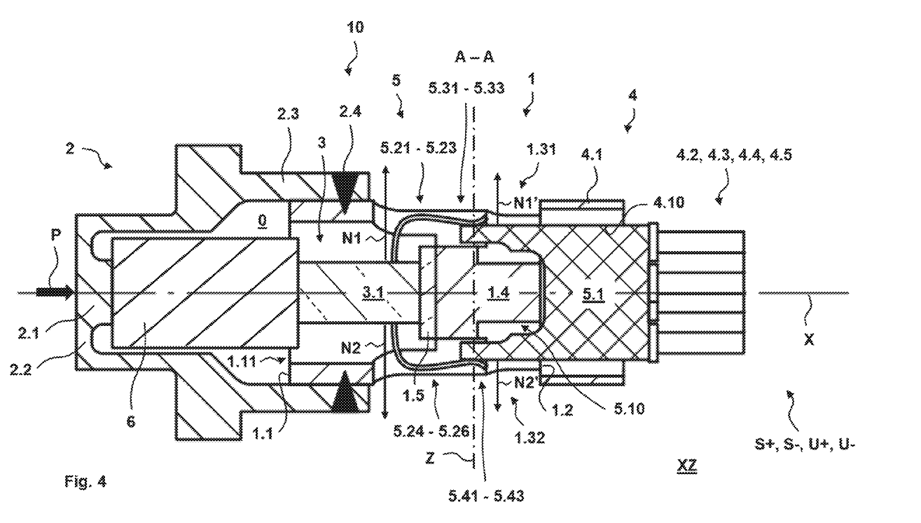

The pressure P originates from a medium, which can be a fluid that may be gaseous and/or liquid. The medium may contain hydrogen, with a hydrogen content of more than or equal to 1 vol%. The pressure P is less than or equal to 2500 bar. In FIGS. 3 and 4, the pressure P is schematically represented as an arrow acting in the longitudinal direction on the diaphragm element 2. A container in which the medium is placed is not shown in the figures.

### The Inner Housing Part 1

The inner housing part 1 is configured to perform the function of accommodating the measuring unit 3 and the tapping unit 5.

In the two embodiments of the sensor 10 according to FIGS. 1 to 4, the inner housing part 1 is hollow cylindrical in shape. The inner housing part 1 is made of a mechanically resistant metallic material such as a high-alloy stainless steel and the like. Preferably, the inner housing part 1 is a unitary structure that is manufactured in one piece rather than as multiple pieces that are fused together to form the whole.

In the two embodiments of the sensor 10 according to FIGS. 1 to 4, the inner housing part 1 defines a first housing end 1.1 and a second housing end 1.2 that is spaced apart from the first housing end 1.1 in the longitudinal direction. The inner housing part 1 is defined by a housing wall 1.3 that forms a cylindrical shell surrounding the longitudinal axis X in the radial direction. A cylindrical surface defines the inside of the inner housing part 1 and delimits a cavity 0 between the first housing end 1.1 and the second housing end 1.2 in the longitudinal direction. Thus, the inner housing part 1 delimits the cavity 0 with the housing wall 1.3 in the radial direction. A cylindrical surface concentric with the inside of the inner housing part 1 defines an outside of the inner housing part. The measuring unit 3 and the tapping unit 5 are completely accommodated in the cavity 0. The feedthrough 4 is partially arranged within the cavity 0.

The inner housing part 1 defines an axial opening 1.11. In the two embodiments of the sensor 10 as shown in FIGS. 1 to 4, the axial opening 1.11 is located at the first housing end 1.1. The cavity 0 at the first housing end 1.1 can be accessed from the outside of the inner housing part 1 in the longitudinal direction through the axial opening 1.11.

In the two embodiments of the sensor 10 according to FIGS. 1 to 4, the inner housing part 1 defines a first radial opening 1.31 and a second radial opening 1.32 spaced apart from the first radial opening 1.31 in the radial direction and the circumferential direction. The two radial openings 1.31, 1.32 are defined through the housing wall 1.3 of the inner housing part 1. Each of the radial openings 1.31, 1.32 is configured in size and shape to permit the cavity 0 to be accessed by a manufacturing tool from the outside of the inner housing part 1 in the radial direction through each of the two radial openings 1.31, 1.32. Preferably, the two radial openings 1.31, 1.32 extend along the vertical axis Z from outside of the inner housing part 1 to the cavity 0.

The two radial openings 1.31, 1.32 are cut through the housing wall 1.3 in such a way that the measuring unit 3, the tapping unit 5, and the feedthrough 4 are accessible, for example by a bonding tool, in the radial direction from outside of the inner housing part 1 through the two radial openings 1.31, 1.32. Each of the two radial openings 1.31, 1.32 is configured with a size and shape sufficient to allow for electrical contacting, such as ultrasonic wedge bonding, ball-ball wedge bonding and the like, to be carried out at the measuring unit 3, the tapping unit 5, and the feedthrough 4 within the cavity 0. In fulfilling this structural requirement, each of the two radial openings 1.31 and 1.32 elongates in the direction of the longitudinal axis x and circumferentially as shown schematically in FIGS. 1 - 4.

As shown in FIGS. 1 – 4 and 12 – 15, the inner housing part 1 comprises a support body 1.4 that is configured and disposed to perform the function of absorbing the force flux of the pressure P to be measured. In the two embodiments of the sensor 10 as shown in FIGS. 1 to 4, the support body 1.4 is arranged at the second housing end 1.2. Preferably, the support body 1.4 is arranged so as to be aligned along the longitudinal axis X that is the path of the force flux of the pressure P to be measured.

In the first embodiment of the sensor 10 as shown in FIGS. 1 and 3, one side of the measuring unit 3 rests against the support body 1.4 in the longitudinal direction.

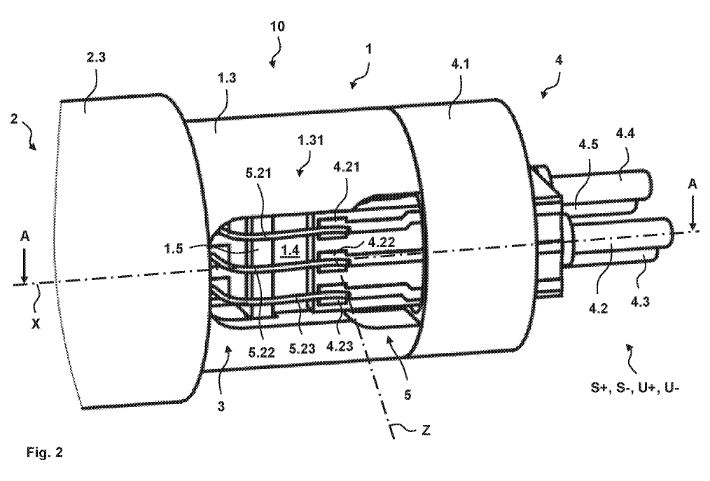

In the second embodiment of the sensor 10 as shown in FIGS. 2 and 4, the inner housing part 1 includes an insulator body 1.5. The insulator body 1.5 is configured and disposed to perform the function of electrically insulating the measuring unit 3 from the support body 1.4 in the longitudinal direction X. In the second embodiment of the sensor 10 as shown in FIGS. 2 and 4, the insulator body 1.5 is, therefore, arranged between the measuring unit 3 and the support body 1.4 in the longitudinal direction. Thus, the measuring unit 3 abuts with one side against the insulator body 1.5 in the longitudinal direction. The insulator body 1.5 consists of an electrically insulating material such as aluminum oxide, ceramic, sapphire and the like.

### The Diaphragm Element 2

The diaphragm element 2 is configured to perform the function of conducting the pressure P to be measured into the cavity 0.

In the two embodiments of the sensor 10 as shown in FIGS. 1 to 4, the diaphragm element 2 is also hollow cylindrical in shape. As shown in the cross-sectional views of FIGS. 3 and 4, the diaphragm element 2 is open at one end that is opposite a blind end, which is configured to be disposed for direct interaction with the pressure P to be measured. The diaphragm element 2 is made of a mechanically resistant metallic material such as a high-alloy stainless steel and the like. The diaphragm element 2 is preferably manufactured in one piece as a unitary structure.

The diaphragm element 2 is arranged at the first housing end 1.1. In the two embodiments of the sensor 10 as shown in FIGS. 1 to 4, the diaphragm element 2 closes up the axial opening 1.11 to the cavity 0 in the longitudinal direction. The cavity 0 extends from the inner housing part 1 to the diaphragm element 2 in the longitudinal direction along the longitudinal axis X. Thus, the cavity 0 extends not only within the inner housing part 1 but also within the diaphragm element 2. The diaphragm element 2 is partially defined by a cylindrically configured diaphragm wall 2.3 in the radial direction from the longitudinal axis X. Thus, the diaphragm element 2 delimits the cavity 0 in the radial direction by the diaphragm wall 2.3, which forms a cylindrical shell that elongates from the blind end along the longitudinal axis X.

The blind end of the diaphragm element 2 includes a material thickening on the longitudinal axis X that is hereinafter referred to as the protrusion 2.1. In a region of the blind end disposed radially outwardly from the longitudinal axis X in the radial direction, the diaphragm element 2 is defined by a material thinning that is hereinafter referred to as the joint 2.2. As represented in FIGS. 3 and 4, the joint 2.2 is formed in the annular shape of a ring concentrically surrounding the protrusion 2.1 in the radial direction from the longitudinal axis X. Under the effect of the pressure P, the joint 2.2 enables displacement of the protrusion 2.1 in the longitudinal direction. By this varying displacement, the protrusion 2.1 transmits the pressure P to be measured along the longitudinal axis X and into the cavity 0.

The diaphragm wall 2.3 protrudes in another region outward of the joint 2.2 in the radial direction. This radially protruding region of the diaphragm wall 2.3 can be used for mounting or defining a connecting means arranged on an outward side of the diaphragm wall 2.3 that faces away from the cavity 0. By the connecting means, the sensor 10 can be secured to a container that accommodates the medium. While a specific embodiment of a suitable connecting means is not shown in the Figures, the connecting means may be designed as a union nut, mounting sleeve, external thread and the like for establishing a screw connection to the container.

An inner diameter of the open end of the diaphragm wall 2.3 in the radial direction is preferably larger than an outer diameter of the housing wall 1.3 so that it is possible to slide the diaphragm wall 2.3 over the housing wall 1.3 in the longitudinal direction in a telescoping manner.

The open end of the diaphragm wall 2.3 is attached to the housing wall 1.3 by a first material-bonded connection 2.4. As shown in FIGS. 3 and 4, the first material-bonded connection 2.4 is preferably designed as at least one weld seam extending circumferentially around the longitudinal axis X.

Instead of connecting the diaphragm wall 2.3 directly to the housing wall 1.3 as shown in FIGS. 3 and 4, a person skilled in the art may also use indirect attachment of the diaphragm wall 2.3 at the housing wall 1.3 by means of a hollow cylindrical spacer inserted between the two telescoping members. The spacer desirably is made from the same mechanically resistant metallic material as the diaphragm element 2 and the inner housing part 1. In this case, a person skilled in the art creates two first material-bonded connections, a first material-bonded connection between the diaphragm wall 2.3 and the spacer and a second material-bonded connection between the spacer and the housing wall 1.3.

### The Measuring Unit 3

The measuring unit 3 is configured to perform the function of generating at least one measurement signal S+, S- for the pressure P to be measured.

As shown in FIGS. 3 and 4, the measuring unit 3 includes a supporting body 3.1, which desirably consists of electrically insulating material such as silicon, silicon dioxide, borosilicate glass, silicon carbide and the like.

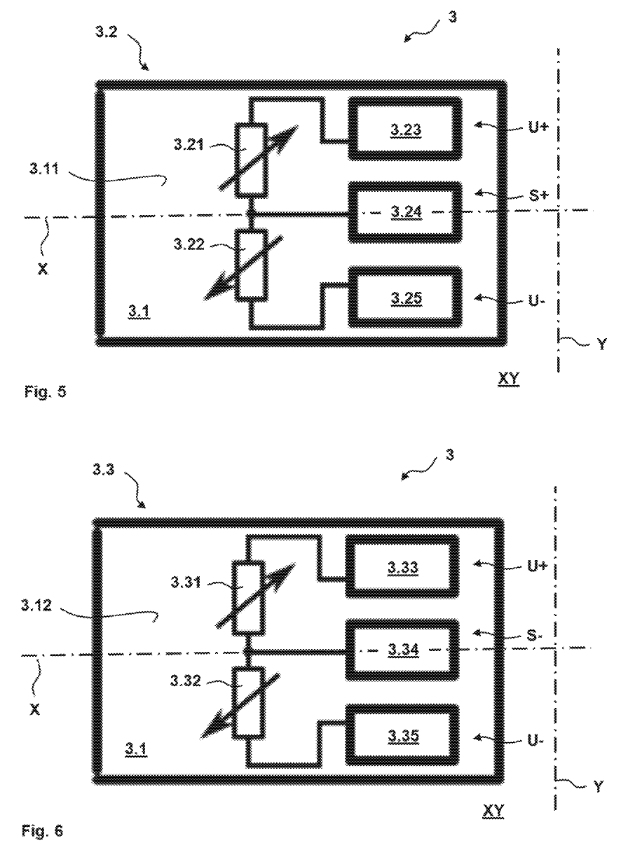

Preferably, the supporting body 3.1 is a solid structure that is cuboid in shape and thus is defined externally by a plurality of surfaces, which are planar in shape. In the following, two of the plurality of surfaces will be referred to as the first supporting surface 3.11 and the second supporting surface 3.12. Though the supporting surfaces 3.11 and 3.12 are not separately depicted in FIGS. 1 and 2 to avoid unduly complicating these figures, details of the supporting body 3 can be found in FIGS. 5 and 6, which are cut in the XY plane from FIGS. 1 and 2. As schematically shown in FIGS. 5 and 6, each of the two supporting surfaces 3.11, 3.12 extends in the longitudinal direction and parallel to the transverse plane XY.

Because of their planar shape, the first supporting surface 3.11 defines a first supporting surface normal N1, and the second supporting surface 3.12 defines a second supporting surface normal N2. As shown in FIGS. 3 and 4, the first supporting surface normal N1 extends from the longitudinal axis X in the radial direction at a right angle along the vertical axis Z through the radial opening 1.31, and the second supporting surface normal N2 extends from the longitudinal axis X in the radial direction at a right angle along the vertical axis Z through the second radial opening 1.32. Preferably, the supporting surface normals N1 and N2 are parallel to the vertical axis Z. Thus, the supporting surface normals N1, N2 extend at an angle of 0° from the vertical axis Z through the two radial openings 1.31 and 1.32. The supporting surface normals N1 and N2 are at an angle of greater than zero with respect to each other. Preferably, the supporting surface normals N1 and N2 are at an angle of 180° with respect to each other.

The measuring unit 3 is arranged on the longitudinal axis X in the path of the force flux of the pressure P to be measured. The measuring unit 3 operates according to the piezoresistive measuring principle. The supporting body 3.1 is preferably a silicon on insulator (SOI) that uses a thin layer of silicon dioxide SiO₂ as an oxide insulator layer that is arranged underneath each supporting surface 3.11, 3.12, which is an active silicon layer.

As schematically shown in FIGS. 5 and 6, the supporting surfaces 3.11, 3.12 include a plurality of electrical resistance elements 3.21, 3.22, 3.31, 3.32 made of piezoresistive material such as boron-doped silicon and the like. Due to the oxide layers of the supporting surfaces 3.11, 3.12, the electrical resistance elements 3.21, 3.22, 3.31, 3.32 formed in the supporting surfaces 3.11, 3.12 are electrically insulated from each other. The electrical resistance elements 3.21, 3.22, 3.31, 3.32 are three-dimensionally structured in height, length, and width.

The supporting surfaces 3.11, 3.12 include a plurality of electrical conductor elements made of an electrically conductive material such as highly doped silicon, aluminum, titanium, tungsten and the like. The electrical conductors formed in the supporting surfaces 3.11, 3.12 are also electrically insulated from each other by oxide layers of the supporting surfaces 3.11, 3.12. The electrical conductor elements are three-dimensionally structured in height, length, and width. However, the electrical conductor elements are not schematically depicted and designated by reference numerals in FIGS. 5 and 6.

The electrical resistance elements 3.21, 3.22, 3.31, 3.32 are connected by the electrical conductor elements to form a Wheatstone Bridge circuit.

Applying and structuring of the electrical resistance elements 3.21, 3.22, 3.31, 3.32 and the electrical conductor elements on the supporting surfaces 3.11, 3.12 of the solid supporting body 3.1 is carried out by means of chemical vapor deposition, physical vapor deposition, epitaxy, lithography, etching and the like. Forming these elements on the solid supporting body 3.1 significantly reduces the chances of damaging these elements during handling of the supporting body 3.1, both before and during the process of manufacturing the sensor 10.

As schematically shown in FIGS. 5 and 6, the measuring unit 3 includes a first measuring circuit 3.2 and a second measuring circuit 3.3. The first measuring circuit 3.2 is supported by the first supporting surface 3.11, and the second measuring circuit 3.3 is supported by the second supporting surface 3.12.

The first measuring circuit 3.2 includes first electrical resistance elements 3.21, 3.22. The second measuring circuit 3.3 includes second electrical resistance elements 3.31, 3.32. Preferably, each of the two measuring circuits 3.2, 3.3 includes two electrical resistance elements 3.21, 3.22, 3.31, 3.32. According to FIG. 5, the first measuring circuit 3.2 includes an alpha first electrical resistance element 3.21 and a beta first electrical resistance element 3.22 that form a half-bridge portion of a Wheatstone bridge circuit. According to FIG. 6, the second measuring circuit 3.3 an alpha second electrical resistance element 3.31 and a beta second electrical resistance element 3.32 that also form a half-bridge portion of a Wheatstone bridge circuit.

Each of the two measuring circuits 3.2, 3.3 being disposed on a respective opposite side of the supporting body 3.1 is electrically connected to each other to combine to form a Wheatstone Bridge circuit. By displacement of the protrusion 2.1 in the longitudinal direction, the pressure P is introduced onto the Wheatstone Bridge circuit as a force flux. When an operating voltage U+, U- is applied to the Wheatstone Bridge circuit, the introduced pressure P causes a change in electrical resistance in the Wheatstone Bridge circuit. This change in electrical resistance is proportional to the pressure P to be measured and can be tapped as the measurement signal S+, S-.

The first electrical resistance elements 3.21, 3.22 and the second electrical resistance elements 3.31, 3.32 of the two measuring circuits 3.2, 3.3 are connected in series as schematically shown in FIGS. 5 and 6. Each of the series connections of the two measuring circuits 3.2, 3.3 includes a first end and a second end. Preferably, each of the two measuring circuits 3.2, 3.3 includes a first, second, and third contacting point. The first contacting point is located at the first end of the series connections, the second contacting point is located at the second end of the series connections, and the third contacting point is located between the two electrical resistance elements 3.21, 3.22, 3.31, 3.32 of the series connections. The contacting points are not designated by reference numerals in FIGS. 5 and 6.

As schematically shown in FIGS. 5 and 6, the first measuring circuit 3.2 includes a plurality of first contacting sites 3.23, 3.24 and 3.25 and the second measuring circuit 3.3 includes a plurality of second contacting points 3.33, 3.34 and 3.35. Each of the plurality of contacting sites 3.23 – 3.25 and 3.33 – 3.35 is configured and disposed to perform the function of providing electrical contacts between the measuring unit 3 and the feedthrough 4.

Each of the plurality of first and second contacting sites 3.23 – 3.25, 3.33 – 3.35 is made of electrically conductive material such as copper, silver, gold and the like. Applying and structuring each of the plurality of first and second contacting sites 3.23 – 3.25, 3.33 – 3.35 on the supporting surfaces 3.11, 3.12 is carried out by means of chemical vapor deposition, physical vapor deposition, epitaxy, screen printing, electroplating, lithography, etching and the like.

Each of the plurality of first and second contacting sites 3.23 – 3.25, 3.33 – 3.35 is configured as a flat planar extension parallel to the transverse plane XY and designed to be large enough to enable electrical contacting such as ultrasonic wedge bonding, ball-ball wedge bonding and the like to be carried out during the process of manufacturing the sensor 10.

The first electrical resistance elements 3.21, 3.22 are electrically connected to the first contacting sites 3.23 – 3.25 by means of electrical conductor elements. The second electrical resistance elements 3.31, 3.32 are electrically connected to the second contacting sites 3.33 – 3.35 by means of electrical conductor elements.

Preferably, the first measuring circuit 3.2 includes three first contacting sites 3.23 – 3.25, and the second measuring circuit 3.3 includes three second contacting sites 3.33 – 3.35. The plurality of first contacting sites 3.23 – 3.25 include an alpha first contacting site 3.23, a beta first contacting site 3.24, and a gamma first contacting site 3.25. The plurality of second contacting sites 3.33 – 3.35 include an alpha second contacting site 3.33, a beta second contacting site 3.34, and a gamma second contacting site 3.35.

Preferably, the first measuring circuit 3.2 as shown in FIG. 5 includes three electrical conductor elements wherein each of the three electrical conductor elements electrically connects a different one of the three contacting points of the first measuring circuit 3.2 with exactly one of the three first contacting sites 3.23 – 3.25. As shown in FIG. 6, the second measuring circuit 3.3 also includes three electrical conductor elements wherein each of the three electrical conductor elements electrically connects a different one of the three contacting points of the second measuring circuit 3.3 with exactly one of the three second contacting sites 3.33 – 3.35.

When the operating voltage U+, U- is applied to at least two contacting sites 3.23, 3.25 of the first contacting sites 3.23 – 3.25 and to at least two contacting sites 3.33, 3.35 of the second contacting sites 3.33 – 3.35, the pressure P introduced onto the Wheatstone Bridge circuit causes a change in resistance, which change in resistance can be detected as the measurement signal S+, S- that reaches at least one contacting site 3.24 of the first contacting sites 3.23 – 3.25 and that reaches at least one contacting site 3.34 of the second contacting sites 3.33 – 3.35.

The operating voltage U+, U- includes a positive operating voltage U+ and a negative operating voltage U-. The measurement signal S+, S- includes a positive measurement signal S+ and a negative measurement signal S-.

As shown in FIG. 5, the positive operating voltage U+ is applied to the first measuring circuit 3.2 via the alpha first contacting site 3.23 and the positive measurement signal S+ can be tapped at the beta first contacting site 3.24, and the negative operating voltage U- is applied at the gamma first contacting site 3.25. As shown in FIG. 6, the positive operating voltage U+ is applied to the second measuring circuit 3.3 via the alpha second contacting site 3.33 and the negative measurement signal S- can be tapped at the beta second contacting site 3.34, and the negative operating voltage U- is applied at the gamma second contacting site 3.35.

### The Tapping Unit 5

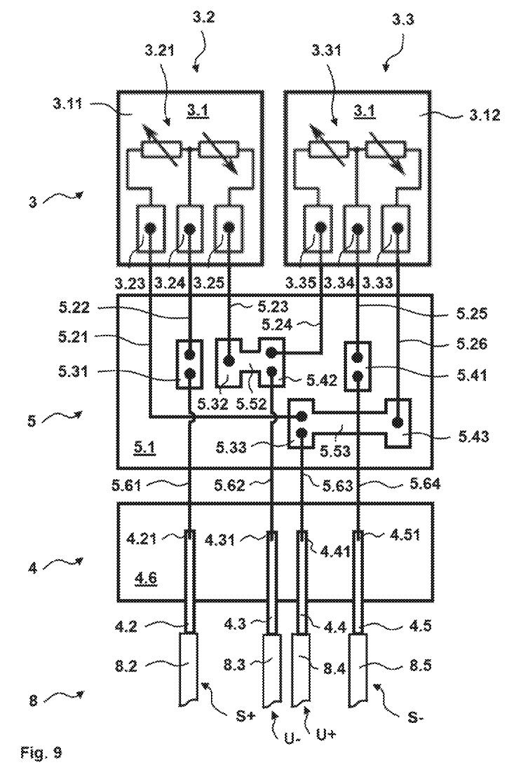

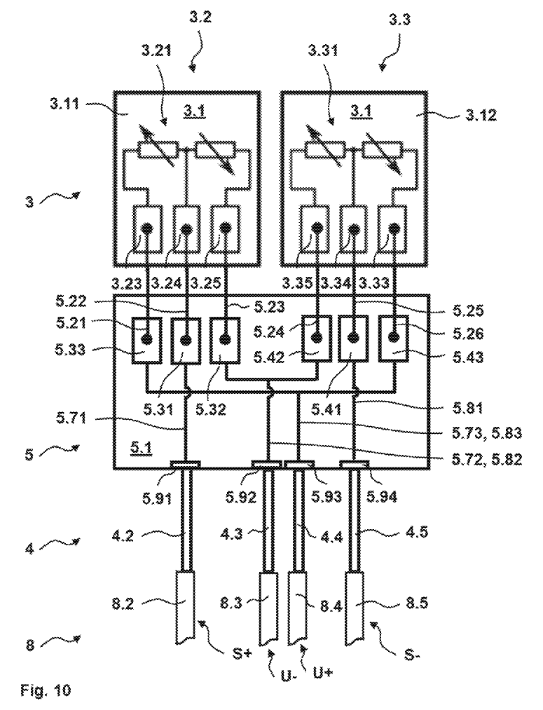

The tapping unit 5 is configured and disposed to perform the function of tapping and transmitting the measurement signal S+, S- from the measuring unit 3 to the feedthrough 4 and of conducting the operating voltage U+, U- from the feedthrough 4 to the measuring unit 3. As explained more fully below, the tapping unit 5 is configured and disposed to facilitate electrical connections between the measuring unit 3 and the feedthrough 4 in a way that accommodates the differently sized electrical contact points of each of the measuring unit 3 and the feedthrough. Moreover, as evident from FIGS. 9 and 10, the tapping unit 5 is configured to mediate the electrical signal traffic generated by the two half-bridge circuits of the measuring unit 3 from the six contacting sites 3.23, 3.24. 3.25. 3.33, 3.34, 3.35 to the four pin elements 4.2, 4.3, 4.4, 4.5 of the feedthrough 4. Additionally, the tapping unit 5 is configured and disposed to facilitate using a plurality of conductor elements 5.21 – 5.26, 5.61 – 5.64 that can be robotically installed to make electrical connections between the measuring unit 3 and the feedthrough 4 during the process of manufacturing the sensor 10.

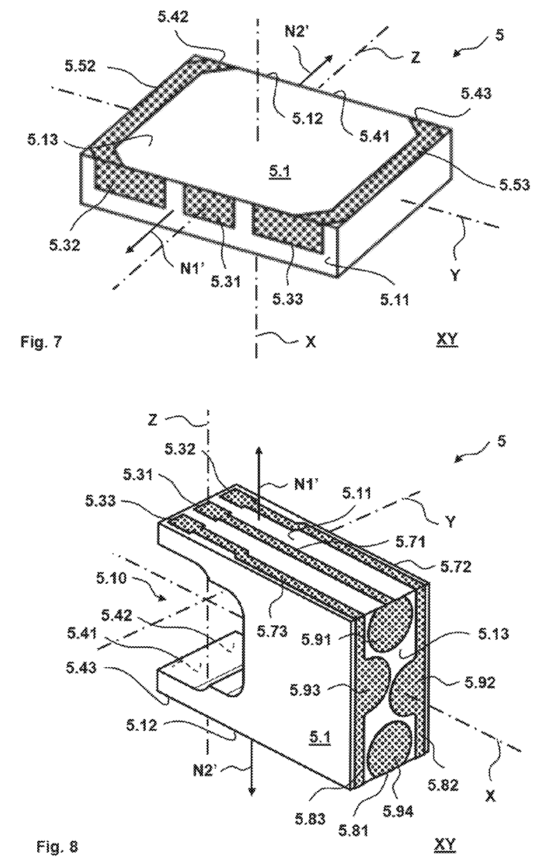

FIGS. 7 and 8 show details of the tapping unit 5 shown in cross-section in FIGS. 3 and 4. FIG. 7 shows a perspective view of a first embodiment of the tapping unit 5. FIG. 8 shows a perspective view of a second embodiment of the tapping unit 5. The tapping unit 5 includes a contact body 5.1 that consists of an electrically insulating material such as aluminum oxide, ceramic, sapphire and the like.

The contact body 5.1 is preferably is a solid structure that is cuboid in shape and is defined externally by a plurality of surfaces, which desirably are planar in shape. In the following description, two of the plurality of surfaces will be referred to as the first contact surface 5.11 and as the second contact surface 5.12. As shown in FIGS. 7 and 8, each of the two contact surfaces 5.11, 5.12 extends in the longitudinal direction parallel to the transverse plane XY, but on opposing sides of the contact body 5.1. A third surface is hereinafter referred to as the further surface 5.13. The further surface 5.13 extends between the first and second contact surfaces 5.11, 5.12 in the radial direction perpendicular to the transverse plane XY. The further surface 5.13 adjoins the first contact surface 5.11 and the second contact surface 5.12.

Because of their planar shape, as shown in FIGS. 7 and 8, the first contact surface 5.11 defines a first contact surface normal N1’, and the second contact surface 5.12 defines a second contact surface normal N2’. As shown in FIGS. 3 and 4, the first contact surface normal N1’ extends from the longitudinal axis X in the radial direction at a right angle through the radial opening 1.31, and the second contact surface normal N2’ extends from the longitudinal axis X in the radial direction at a right angle through the second radial opening 1.32. Preferably, the contact surface normals N1’, N2’ are parallel to the vertical axis Z. Thus, the contact surface normals N1’, N2’ extend with respect to the vertical axis Z at an angle of 0° through the two radial openings 1.31, 1.32. The contact surface normals N1’, N2’ are at an angle of greater than zero with respect to each other. Preferably, the contact surface normals N1’, N2’ are at an angle of 180° with respect to each other.

The tapping unit 5 includes a plurality of contacting sites 5.31, 5.32, 5.33, 5.41, 5.42, 5.43, 5.91, 5.92, 5.93, and 5.94 and a plurality of electrical conductor paths 5.52, 5.53, 5.71, 5.72, 5.73, 5.81, 5.82, and 5.83. Each of the contacting sites 5.31 – 5.33, 5.41 – 5.43, 5.91 – 5.94 and the electrical conductor paths 5.52, 5.53, 5.71 – 5.73, 5.81 – 5.83 is configured and disposed to perform the function of providing electrical paths between the six contact sites 3.23, 3.24, 3.25, 3.33, 3.34, 3.35 of the measuring unit 3 and the four contact pin elements 4.2, 4.3, 4.4, 4.5 of the feedthrough 4.

The contacting sites 5.31 – 5.33, 5.41 – 5.43, 5.91 – 5.94 and the electrical conductor paths 5.52, 5.53, 5.71 – 5.73, 5.81 – 5.83 are made of electrically conductive material such as copper, silver, gold and the like. The contacting sites 5.31 – 5.33, 5.41 – 5.43, 5.91 – 5.94 and the electrical conductor paths 5.52, 5.53, 5.71 – 5.73, 5.81 – 5.83 are arranged on the contact body 5.1. Applying and structuring the contacting sites 5.31 – 5.33, 5.41 – 5.43, 5.91 – 5.94 and the electrical conductor paths 5.52, 5.53, 5.71 – 5.73, 5.81 – 5.83 on the contact body 5.1 is carried out by means of chemical vapor deposition, physical vapor deposition, epitaxy, screen printing, electroplating, lithography, etching and the like.

The contacting sites 5.31 – 5.33, 5.41 – 5.43, 5.91 – 5.94 include a plurality of third contacting sites 5.31 – 5.33, fourth contacting sites 5.41 – 5.43, and fifth contacting sites 5.91 – 5.94.

In the two embodiments of the tapping unit 5 as shown in FIGS. 7 and 8, the third contacting sites 5.31 – 5.33 are arranged on the first contact surface 5.11, and the fourth contacting sites 5.41 – 5.43 are arranged on the second contact surface 5.12. Preferably, the tapping unit 5 includes three third contacting sites 5.31 – 5.33 and three fourth contacting sites 5.41 – 5.43. The third contacting sites 5.31 – 5.33 include an alpha third contacting site 5.31, a beta third contacting site 5.32, and a gamma third contacting site 5.33, and the fourth contacting sites 5.41 – 5.43 include an alpha fourth contacting site 5.41, a beta fourth contacting site 5.42, and a gamma fourth contacting site 5.43.

Each of the third and fourth contacting sites 5.31 – 5.33, 5.41 – 5.43 includes a flat surface that extends parallel to the transverse plane XY and that is configured to be large enough to enable electrical contacting such as ultrasonic wedge bonding, ball-ball wedge bonding and the like to be carried out.

The second embodiment of the tapping unit 5 according to FIG. 8 includes a plurality of fifth contacting sites 5.91 – 5.94. The fifth contacting sites 5.91 – 5.94 are arranged on the further surface 5.13 of the contact body 5.1. The fifth contacting sites 5.91 – 5.94 include an alpha fifth contacting site 5.91, a beta fifth contacting site 5.92, a gamma fifth contacting site 5.93, and a delta fifth contacting site 5.94.

The electrical conductor paths 5.52, 5.53, 5.71 – 5.73, 5.81 – 5.83 include first electrical conductor paths 5.52, 5.53, second electrical conductor elements 5.71, 5.72 and 5.73, and third electrical conductor elements 5.81, 5.82 and 5.83.

The first embodiment of the tapping unit 5 according to FIG. 7 includes first electrical conductor paths 5.52, 5.53. The first electrical conductor paths 5.52, 5.53 include an first alpha first electrical conductor path 5.52 and a beta first electrical conductor path 5.53. The first electrical conductor paths 5.52, 5.53 are arranged on the further surface 5.13 of the contact body 5.1.

The alpha third contacting site 5.32 on the first contact surface 5.11 and the beta fourth contacting site 5.42 on the second contact surface 5.12 are electrically connected to each other via the alpha first electrical conductor path 5.52 of the further surface 5.13.

The gamma third contacting site 5.33 on the first contact surface 5.11 and the gamma fourth contacting site 5.43 on the second contact surface 5.12 are electrically connected to each other via the beta first electrical conductor path 5.53 on a further surface 5.13.

The second embodiment of the tapping unit 5 according to FIG. 8 comprises second electrical conductor paths 5.71, 5.72 and 5.73 and third electrical conductor paths 5.81, 5.82 and 5.83.

The second electrical conductor paths 5.71 – 5.73 include an alpha second electrical conductor path 5.71, a beta second electrical conductor path 5.72, and a gamma second electrical conductor path 5.73. The third electrical conductor paths 5.81 – 5.83 include an alpha third electrical conductor path 5.81, a beta third electrical conductor path 5.82, and a gamma third electrical conductor path 5.83. The second electrical conductor paths 5.71 – 5.73 are arranged on the first contact surface 5.11 and on the further surface 5.13 of the contact body 5.1. The third electrical conductor paths 5.81 – 5.83 are arranged on the second contact surface 5.12 and on the further surface 5.13 of the contact body 5.1.

The alpha third contacting site 5.31 on the first contact surface 5.11 is electrically connected to the alpha fifth contacting site 5.91 on the further surface 5.13 via the alpha second electrical conductor path 5.71 of the first contact surface 5.11.

The alpha fourth contacting site 5.41 on the second contact surface 5.12 is electrically connected to the delta fifth contacting site 5.94 on the further surface 5.13 via the alpha third electrical conductor path 5.81 of the second contact surface 5.12.

The beta third contacting site 5.32 on the first contact surface 5.11 is electrically connected to the beta fifth contacting site 5.92 on the further surface 5.13 via the beta second electrical conductor path 5.72 of the first contact surface 5.11 and the further surface 5.13. The beta fourth contacting site 5.42 on the second contact surface 5.12 is electrically connected to the beta fifth contacting site 5.92 on the further surface 5.13 via the beta third electrical conductor path 5.82 of the second contact surface 5.12 and the further surface 5.13.

The gamma third contacting site 5.33 on the first contact surface 5.11 is electrically connected to the gamma fifth contacting site 5.93 on the further surface 5.13 via the gamma second electrical conductor path 5.73 of the first contact surface 5.11 and the further surface 5.13. The gamma fourth contacting site 5.43 on the second contact surface 5.12 is electrically connected to the gamma fifth contacting site 5.93 on the further surface 5.13 via the gamma third electrical conductor path 5.83 of the second contact surface 5.12 and the further surface 5.13.

The tapping unit 5 includes a plurality of conductor elements 5.21, 5.22, 5.23, 5.24, 5.25 and 5.26, and 5.61, 5.62, 5.63 and 5.64. Each of the conductor elements 5.21 – 5.26, 5.61 – 5.64 is configured and disposed to perform the function of establishing electrical contacts in the electrical circuitry of the sensor 10.

Details of the electrical circuitry of the sensor 10 can be found schematically represented in FIGS. 9 and 10. FIG. 9 shows the electrical circuitry of the first embodiment of the sensor 10 according to FIG. 1 with the first embodiment of the tapping unit 5 according to FIG. 7. FIG. 10 shows the electrical circuitry of the second embodiment of the sensor 10 according to FIG. 2 with the second embodiment of the tapping unit 5 according to FIG. 8.

The conductor elements 5.21, 5.22, 5.23, 5.24, 5.25 and 5.26, and 5.61, 5.62, 5.63 and 5.64 are made of an electrically conductive material such as copper, silver, gold and the like.

In the two embodiments of the electrical circuitry of the sensor 10 as shown in FIGS. 9 and 10, the two embodiments of the tapping unit 5 include six first conductor elements 5.21 – 5.26. The plurality of first conductor elements 5.21 – 5.26 includes an alpha first conductor element 5.21, a beta first conductor element 5.22, a gamma first conductor element 5.23, a delta first conductor element 5.24, an epsilon first conductor element 5.25, and a zeta first conductor element 5.26.

The alpha first conductor element 5.21 makes an electrical contact between the alpha first contacting site 3.23 and the gamma third contacting site 5.33. The beta first conductor element 5.22 makes an electrical contact between the beta first contacting site 3.24 and the alpha third contacting site 5.31. The gamma first conductor element 5.23 makes an electrical contact between the gamma first contacting site 3.25 and the beta third contacting site 5.32. The delta first conductor element 5.24 makes an electrical contact between the gamma third contacting site 3.35 and the beta fourth contacting site 5.42. The epsilon first conductor element 5.25 makes an electrical contact between the beta third contacting site 3.34 and the alpha fourth contacting site 5.41. The zeta first conductor element 5.26 makes an electrical contact between the alpha second contacting site 3.33 and the gamma fourth contacting site 5.43.

The electrical contacting of the first conductor elements 5.21 – 5.26 on the first contacting sites 3.23 – 3.25, the second contacting sites 3.33 – 3.35, the third contacting sites 5.31 – 5.33, and the fourth contacting sites 5.41 – 5.43 is established by means of ultrasonic wedge bonding, ball-ball wedge bonding and the like.

In the first embodiment of the electrical circuitry of the sensor 10 according to FIG. 9, the first embodiment of the tapping unit 5 includes four second conductor elements 5.61, 5.62, 5.63 and 5.64. The second conductor elements 5.61 – 5.64 include an alpha second conductor element 5.61, a beta second conductor element 5.62, a gamma second conductor element 5.63, and a delta second conductor element 5.64.

The second embodiment of the tapping unit 5 according to FIG. 8 defines a recess 5.10 within the contact body 5.1. The recess 5.10 is cut through the contact body 5.1 perpendicularly to the longitudinal direction between the third contacting sites 5.31 – 5.33 of the first contact surface 5.11 and the fourth contacting sites 5.41 – 5.43 (hidden from the viewer in FIG. 8) of the second contact surface 5.12. As schematically shown in the cross-sectional view of FIG. 4, the force flux of the pressure P to be measured acts from the diaphragm element 2 in the direction pointed by the bold typeface arrow P towards the measuring unit 3 and from the measuring unit 3 onward onto the support body 1.4 of the inner housing part 1. In the section in the vertical plane XZ as shown in FIG. 4, the support body 1.4 is arranged on the longitudinal axis X within the recess 5.10 but not in contact with the contact body 5.1 that includes the respective third and fourth contacting sites 5.31 – 5.33, 5.41 – 5.43. However, as shown in FIG. 8, the respective third and fourth contacting sites 5.31 – 5.33, 5.41 – 5.43 are arranged respectively on the first and second contact surfaces 5.11, 5.12, which extend perpendicularly to the vertical axis Z and outside of the recess 5.10. Thus, the force flux of the pressure P to be measured acts in the longitudinal direction X, passes through the recess 5.10 and does not act on the contact body 5.1. The force flux of the pressure P to be measured is conducted from the support body 1.4 into the second housing end 1.2. Arranging the tapping unit 5 outside of the force flux prevents that pressure peaks of the pressure P to be measured, which pressure peaks are significantly higher than the pressure P, and would otherwise lead to undesired breakage of the tapping unit 5.

### The Feedthrough 4

The feedthrough 4 is configured and disposed to perform the function of conducting the measurement signal S+, S- from the cavity 0 to the outside of the inner housing part 1 and of conducting the operating voltage U+, U- from the outside of the inner housing part 1 to the measuring unit 3.

The feedthrough 4 desirably is cylindrical in shape. As shown in FIGS. 3 and 4, the feedthrough 4 is arranged at the second housing end 1.2, which is positioned furthest from the diaphragm element 2. In the two embodiments of the sensor 10 as shown in FIGS. 1 to 4, the feedthrough 4 closes up the cavity 0 in the longitudinal direction at the second housing end 1.2. In the two embodiments of the sensor 10 as shown in FIGS. 1 and 2, an outer diameter of the feedthrough 4 in the radial direction from the longitudinal axis X is preferably essentially of the same size as the widest end of the outer diameter of the housing wall 1.3.

In the two embodiments of the sensor 10 as shown in FIGS. 1 to 4, the feedthrough 4 includes a feedthrough body 4.1. The feedthrough body 4.1 is made of a mechanically resistant metallic material such as a high-alloy stainless steel and the like.

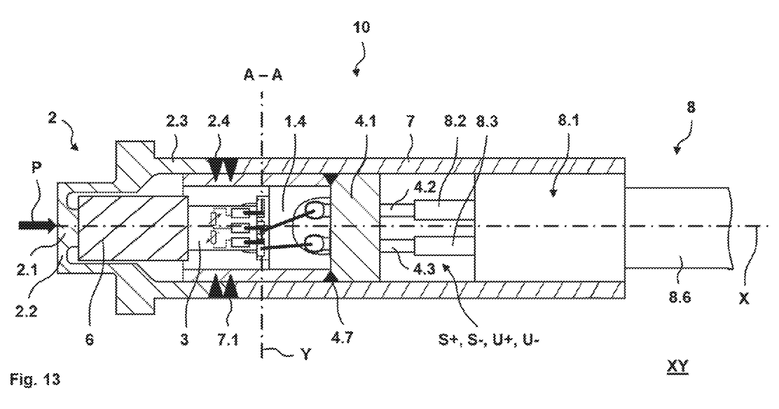

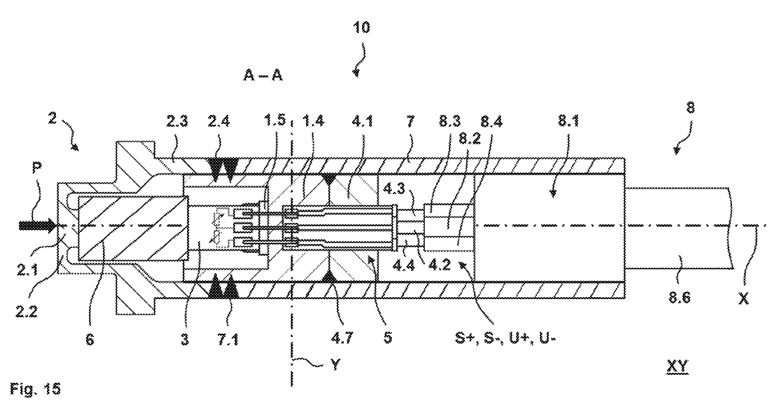

Preferably, the feedthrough 4 is attached to the housing wall 1.3 at the second housing end 1.2 by means of a second material-bonded connection 4.7. Preferably, the second material-bonded connection 4.7 according to FIGS. 13 and 15 is carried out as at least one weld seam extending circumferentially around the longitudinal axis X.

In the two embodiments of the sensor 10 as shown in FIGS. 1 to 4, the feedthrough body 4.1 defines at least one axial through-hole 4.10. The axial through-hole 4.10 extends parallel to the longitudinal axis X and extends from the cavity 0 to the outside of the inner housing part 1. In the first embodiment of the sensor 10 as shown in FIGS. 1 and 3, the feedthrough body 4.1 defines four through-holes 4.10. In the second embodiment of the sensor 10 as shown in FIGS. 2 and 4, the feedthrough body 4.1 defines one axial through-hole 4.10.

In the two embodiments of the sensor 10 as shown in FIGS. 1 to 4, the feedthrough includes four pin elements 4.2, 4.3, 4.4 and 4.5 made of an electrically conductive material such as copper, silver, gold and the like. Preferably, each of the pin elements 4.2 – 4.5 defines a rod-shaped structure often called a prong. Each pin element 4.2 – 4.5 includes a first end and a second end. Each pin element 4.2 – 4.5 projects with its first end into the cavity 0 and with its second end to the outside of the inner housing part 1. Preferably, the feedthrough 4 includes four pin elements 4.2 – 4.5. These four pin elements 4.2 – 4.5 include a first pin element 4.2, a second pin element 4.3, a third pin element 4.4, and a fourth pin element 4.5.

In the first embodiment of the sensor 10 as shown in FIGS. 1 and 3, the first end of each of the pin elements 4.2 – 4.5 is preferably flattened to form one of the sixth contacting sites 4.21, 4.31, 4.41 and 4.51. The flattening facilitates electrically contacting them by the second conductor elements 5.61 – 5.64. Preferably, the first pin element 4.2 defines an alpha sixth contacting site 4.21, the second pin element 4.3 defines a beta sixth contacting site 4.31, the third pin element 4.4 defines a gamma sixth contacting site 4.41, and the fourth pin element 4.5 defines a delta sixth contacting site 4.51.

In the first embodiment of the sensor 10 as shown in FIGS. 1 and 3, the feedthrough 4 includes an insulating element 4.6. The insulating element 4.6 is schematically shown in the electrical circuitry of the sensor 10 according to FIG. 9. The insulating element 4.6 consists of an electrically insulating material such as aluminum oxide, ceramic, sapphire, glass solder and the like. The pin elements 4.2 – 4.5 are embedded in the insulating element 4.6. The pin elements 4.2 – 4.5 are fastened in the axially extending through-hole 4.10 by the insulating element 4.6. Preferably, the insulating element 4.6 is fastened in the axial through-hole 4.10 by means of a material-bonded connection such as a soldered joint and the like. The material-bonded connection is not represented pictorially in the Figures. Thus, the pin elements 4.2 – 4.5 embedded in the insulating element 4.6 are secured in the feedthrough body 4.1 and electrically insulated from the feedthrough body 4.1.

In the first embodiment of the electrical circuitry of the sensor 10 according to FIG. 9, the alpha second conductor element 5.61 makes an electrical contact between the alpha third contacting site 5.31 and the alpha sixth contacting site 4.21 of the first pin element 4.2. The beta second conductor element 5.62 makes an electrical contact between the beta third contacting site 5.32 and the beta sixth contacting site 4.31 of the second pin element 4.3. The gamma second conductor element 5.63 makes an electrical contact between the gamma third contacting site 5.33 and the gamma sixth contacting site 4.41 of the third pin element 4.4. The delta second conductor element 5.64 makes an electrical contact between the delta third contacting point 5.34 and the delta sixth contacting site 4.51 of the fourth pin element 4.5.

In the first embodiment of the electrical circuitry of the sensor 10 according to FIG. 9, the operating voltage U+, U- is applied from at least two pin elements 4.3, 4.4 of the pin elements 4.2 – 4.5 via second conductor elements 5.61 – 5.64, third contacting sites 5.31 – 5.33, fourth contacting sites 5.41 – 5.43, first electrical conductor paths 5.52, 5.53 and first conductor elements 5.21 – 5.26 to at least two contacting sites 3.23, 3.25 of the first contacting sites 3.23 – 3.25 and to at least two contacting sites 3.33, 3.35 of the second contacting sites 3.33 – 3.35.

In the first embodiment of the electrical circuitry of the sensor 10 according to FIG. 9, the operating voltage U+, U- is applied via the second and third pin element 4.3, 4.4 to the measuring unit 3 as follows.

The negative operating voltage U- is applied from the second pin element 4.3 via the beta second conductor element 5.62 to the beta fourth contacting site 5.42. From the beta fourth contacting site 5.42, the negative operating voltage U- is conducted via the delta first conductor element 5.24 to the gamma second contacting site 3.35 of the second measuring circuit 3.3. The beta fourth contacting site 5.42 is electrically connected to the beta third contacting site 5.32 via the alpha electrical conductor path 5.52. From the beta third contacting site 5.32, the negative operating voltage U- is conducted via the gamma first conductor element 5.23 to the gamma first contacting site 3.25 of the first measuring circuit 3.2.

The positive operating voltage U+ is applied from the third pin element 4.4 via the gamma second conductor element 5.63 to the gamma third contacting site 5.33. The gamma third contacting site 5.33 is electrically connected to the gamma fourth contacting site 5.43 via the beta first electrical conductor path 5.53. From the gamma fourth contacting site 5.43, the positive operating voltage U+ is conducted via the zeta first conductor element 5.26 to the alpha second contacting site 3.33 of the second measuring circuit 3.3. From the gamma third contacting site 5.33, the positive operating voltage U+ is conducted via the alpha first conductor element 5.21 to the alpha first contacting site 3.23 of the first measuring circuit 3.2.

In the first embodiment of the electrical circuitry of the sensor 10 according to FIG. 9, the measurement signal S+, S- can be tapped at two pin elements 4.2, 4.5 of the plurality of pin elements 4.2 – 4.5 via second conductor elements 5.61 – 5.64, third contacting sites 5.31 – 5.33, fourth contacting sites 5.41 – 5.43, and first conductor elements 5.21 – 5.26 from at least one contacting site 3.24 of the first contacting sites 3.23 – 3.25 and from at least one contacting site 3.34 of the second contacting sites 3.33 – 3.35.

In the first embodiment of the electrical circuitry of the sensor 10 according to FIG. 9, the measurement signal S+, S- can be tapped from the measuring unit 3 at the first and fourth pin elements 4.2, 4.5 as follows.

The positive measurement signal S+ can be tapped at the first pin element 4.2 via the alpha second conductor element 5.61, the alpha third contacting site 5.31, the beta first conductor element 5.22 from the beta first contacting site 3.24 of the first measuring circuit 3.2.

The negative measurement signal S- can be tapped at the fourth pin element 4.5 via the delta second conductor element 5.64, the alpha fourth contacting site 5.41, the epsilon first conductor element 5.25 from the beta second contacting site 3.34 of the second measuring circuit 3.3.

Thus, in the first embodiment of the electrical circuitry of the sensor 10 according to FIG. 9, the electrical contacting of the measuring element 3 to the feedthrough 4 is achieved via six first conductor elements 5.21 – 5.26 and four second conductor elements 5.61 – 5.64. By the overall ten conductor elements 5.21 – 5.26, 5.61 – 5.64, twenty electrical contacts are established through the radial openings 1.31, 1.32 of the housing wall 1.3 on the first contacting sites 3.23 – 3.25, the second contacting sites 3.33 – 3.35, the third contacting sites 5.31 – 5.33, and the fourth contacting sites 5.41 – 5.43.

In the second embodiment of the electrical circuitry of the sensor 10 according to FIG. 10, the first pin element 4.2 makes an electrical contact with the alpha fifth contacting site 5.91. The second pin element 4.3 makes an electrical contact with the beta fifth contacting site 5.92. The third pin element 4.4 makes an electrical contact with the gamma fifth contacting site 5.93. The fourth pin element 4.5 makes an electrical contact with the delta fifth contacting site 5.94. However, the pin elements 4.2 – 4.5 not only are in electrical contact with the fifth contacting sites 5.91 – 5.94, the pin elements 4.2 – 4.5 are also secured to the fifth contacting sites 5.91 – 5.94 by means of a material-bonded connection. Preferably, the material-bonded connection is a solder joint.

In the second embodiment of the sensor 10 as shown in FIGS. 2 and 4, the contact body 5.1 is fastened in the axial through-hole 4.10. Preferably, the contact body 5.1 is fastened in the axial through-hole 4.10 by means of a material-bonded connection such as a solder joint and the like. The material-bonded connection is not shown pictorially in the Figures. Thus, the pin elements 4.2 – 4.5 secured to the fifth contacting sites 5.91 – 5.94 are electrically insulated from the feedthrough body 4.1 by the contact body 5.1.

In the second embodiment of the electrical circuitry of the sensor 10 according to FIG. 10, the operating voltage U+, U- is applied from at least two pin elements 4.3, 4.4 of the plurality of pin elements 4.2 – 4.5 via fifth contacting sites 5.91 – 5.94, third contacting sites 5.31 – 5.33, fourth contacting sites 5.41 – 5.43, second electrical conductor paths 5.71 – 5.73, third electrical conductor paths 5.81 – 5.83 and first conductor elements 5.21 – 5.26 to at least two contacting sites 3.23, 3.25 of the first contacting sites 3.23 – 3.25 and to at least two contacting sites 3.33, 3.35 of the second contacting sites 3.33 – 3.35.

In the second embodiment of the electrical circuitry of the sensor 10 according to FIG. 10, the operating voltage U+, U- is applied to the measuring unit 3 via the second and third pin elements 4.3, 4.4 as follows.

The negative operating voltage U- is applied from the second pin element 4.3 to the beta fifth contacting site 5.92. The beta fifth contacting site 5.92 is electrically connected to the beta fourth contacting site 5.42 via the beta third electrical conductor path 5.82. From the beta fourth contacting site 5.42, the negative operating voltage U- is conducted via the delta first conductor element 5.24 to the gamma second contacting site 3.35 of the second measuring circuit 3.3. The beta fifth contacting site 5.92 is electrically connected to the beta third contacting site 5.32 via the beta second electrical conductor path 5.72. From the beta third contacting site 5.32, the negative operating voltage U- is conducted via the gamma first conductor element 5.23 to the gamma first contacting site 3.25 of the first measuring circuit 3.2. Furthermore, from the beta fourth contacting site 5.42 the negative operating voltage U- is conducted via the delta first conductor element 5.24 to the gamma second contacting site 3.35 of the second measuring circuit 3.3.

The positive operating voltage U+ is applied from the third pin element 4.4 to the gamma fifth contacting site 5.93. The gamma fifth contacting site 5.93 is electrically connected to the gamma fourth contacting site 5.43 via the gamma third electrical conductor path 5.83. From the gamma fourth contacting site 5.43, the positive operating voltage U+ is conducted via the zeta first conductor element 5.26 to the alpha second contacting site 3.33 of the second measuring circuit 3.3. The gamma fifth contacting site 5.93 is electrically connected to the gamma third contacting site 5.33 via the gamma second electrical conductor path 5.73. From the gamma third contacting site 5.33, the positive operating voltage U+ is conducted via the alpha first conductor element 5.21 to the alpha first contacting site 3.23 of the first measuring circuit 3.2.

In the second embodiment of the electrical circuitry of the sensor 10 as shown in FIG. 10, the measurement signal S+, S- can be tapped at¸ i.e., drawn from, at least two pin elements 4.2, 4.5 of the plurality of pin elements 4.2 – 4.5 via third contacting sites 5.31 – 5.33, fourth contacting sites 5.41 – 5.43, second electrical conductor paths 5.71 – 5.73, third electrical conductor paths 5.81 – 5.83 and first conductor elements 5.21 – 5.26 from at least one contacting site 3.24 of the first contacting sites 3.23 – 3.25 and from at least one contacting site 3.34 of the second contacting sites 3.33 – 3.35.

In the second embodiment of the electrical circuitry of the sensor 10 as shown in FIG. 10, the measurement signal S+, S- can be tapped from the measuring unit 3 at the first and fourth pin elements 4.2, 4.5 as follows.

The positive measurement signal S+ can be tapped at the first pin element 4.2 via the alpha fifth contacting site 5.91, the alpha second electrical conductor path 5.71, the alpha third contacting site 5.31, the beta first conductor element 5.22 from the beta first contacting site 3.24 of the first measuring circuit 3.2.

The negative measurement signal S- can be tapped at the fourth pin element 4.5 via the delta fifth contacting site 5.94, the alpha third electrical conductor path 5.81, the alpha fourth contacting site 5.41, and the epsilon first conductor element 5.25 from the beta second contacting site 3.34 of the second measuring circuit 3.3.

Thus, in the second embodiment of the electrical circuitry of the sensor 10 according to FIG. 10, the electrical contacting of the measuring element 3 to the feedthrough 4 is made via six first conductor elements 5.21 – 5.26. By only six conductor elements 5.21 – 5.26 twelve electrical contacts are established through the radial openings 1.31, 1.32 of the housing wall 1.3 on the first contacting sites 3.23 – 3.25, the second contacting sites 3.33 – 3.35, the third contacting sites 5.31 – 5.33 and the fourth contacting sites 5.41 – 5.43.

### The Transmission Element 6

The transmission element 6 is configured and disposed to perform the function of transmitting the pressure P prevailing in the cavity 0 from the diaphragm element 2 to the measuring unit 3. The transmission element 6 also is configured and disposed to perform the function of mitigating differences in the coefficients of thermal expansion of the materials of the housing part 1, the diaphragm element 2, and the measuring unit 3.

In the two embodiments of the sensor 10 as shown in FIGS. 1 to 4, the transmission element 6 is made of a mechanically resistant metallic material such as a high-alloy stainless steel and the like. The transmission element 6 desirably is cylindrical in shape.

The pressure P to be measured may have local pressure peaks, which are significantly higher than the pressure P and which impinge onto the diaphragm element 2 in a locally restricted manner. In order to prevent pressure peaks from traveling unhindered from the diaphragm element 2 up to the measuring unit 3 where they might lead to undesired breakage of the measuring unit 3, the transmission element 6 is arranged on the longitudinal axis X between the diaphragm element 2 and the measuring unit 3. Thus, pressure peaks are guided from the diaphragm element 2 into the transmission element 6 and are transmitted along the length of the transmission element 6 to the measuring unit 3. In this way, the pressure peaks become sufficiently dissipated and attenuated to an amount that is harmless.

The sensor 10 is designed for use at a temperature of up to 450 °C. At such high temperatures, the differences in the coefficients of thermal expansion of the materials of the housing part 1, the diaphragm element 2, and the measuring unit 3 result in thermal stress which may lead to undesired damage of the sensor 10. To mitigate this thermal stress, the material of the transmission element 6 has a coefficient of thermal expansion that is greater in magnitude than the coefficient of thermal expansion of the material of each of the housing part 1, the diaphragm element 2, and the measuring unit 3.

### The Outer Housing Part 7

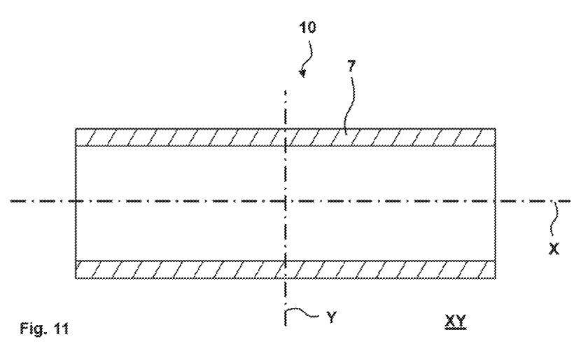

The outer housing part 7 is identical for the two embodiments of the sensor 10 according to FIGS. 1 to 4 and is represented schematically in a cross-sectional view in FIG. 11. The outer housing part 7 is configured and disposed to perform the function of closing the radial openings 1.31, 1.32 of the housing wall 1.3 of the inner housing part 2.

The outer housing part 7 is hollow cylindrical in shape. The outer housing part 7 is made of a mechanically resistant metallic material such as a high-alloy stainless steel and the like. The outer housing part 7 is preferably manufactured in one piece.

The size of an inner diameter of the outer housing part 7 in the radial direction measured along the Y axis in FIG. 11 is such that the outer housing part 7 can be pushed or slid in the longitudinal direction along the X axis in FIG. 11 over the feedthrough 4 onto the inner housing part 1 in a telescoping fashion. When pushed or slid onto the inner housing part 1, the outer housing part 7 closes the radial openings 1.31, 1.32 of the housing wall 1.3. An outer diameter in the radial direction of the outer housing part 7 is preferably essentially equal to the outer diameter of the diaphragm wall 2.3.

Preferably, as schematically shown in FIGS. 13 and 15, after the feedthrough 4 has been attached by means of the second material-bonded connection 4.7 onto the second end 1.2 of the inner housing part 1, the outer housing part 7 is secured to the inner housing part 1 and to the diaphragm element 2 by a third material-bonded connection 7.1. As shown in FIGS. 13 and 15, the third material-bonded connection 7.1 is preferably designed as at least one weld seam extending circumferentially around the longitudinal axis X.

### The Cable 8

The cable 8 is identical for the two embodiments of the sensor 10 as shown in FIGS. 1 to 4. The cable 8 is configured and disposed to perform the function of tapping the measurement signal S+, S- from the feedthrough 4 to the outside of the sensor 10 and of applying the operating voltage U+, U- to the feedthrough 4 from the outside of the sensor 10.

The cable 8 is represented schematically in FIGS. 13 and 15. The cable 8 includes a plurality of third conductor elements 8.2 – 8.5 made of electrically conductive material such as copper, silver, gold and the like.

Preferably, the cable 8 comprises four third conductor elements 8.2 – 8.5. The third conductor elements 8.2 – 8.5 include an alpha third conductor element 8.2, a beta third conductor element 8.3, a gamma third conductor element 8.4, and a delta third conductor element 8.5. As shown in FIGS. 9 and 10, the alpha third conductor element 8.2 makes an electrical contact with the first pin element 4.2 and taps the positive measurement signal S+. The beta third conductor element 8.3 makes an electrical contact with the second pin element 4.3 and applies the negative operating voltage U-. The gamma third conductor element 8.4 makes an electrical contact with the third pin element 4.4 and applies the positive operating voltage U+. The delta third conductor element 8.5 makes an electrical contact with the fourth pin element 4.5 and taps the negative measurement signal S-.

The cable 8 includes a cable insulation 8.1. The cable insulation 8.1 consists of an electrically insulating material such as polytetrafluoroethylene and the like.

The third conductor elements 8.2 – 8.5 are embedded in the cable insulation 8.1 and are electrically insulated from each other by the cable insulation 8.1.

The cable 8 includes a cable sheath 8.6. The cable sheath 8.6 is made of a mechanically resistant material such as polyethylene, polyvinyl chloride and the like. The cable sheath 8.6 surrounds the cable insulation 8.1 radially on the outside thereof in the longitudinal direction X and thus is configured and disposed to protect the third conductor elements 8.2 – 8.5 embedded in the cable insulation 8.1 from mechanical damage.

The cable sheath 8.6 is fastened at the outer housing part 7. The fastening can be achieved by means of plastic deformation such as crimping and the like.

### The Manufacturing process

The process for manufacturing the sensor 10 comprises a plurality of steps S1 – S10. The steps S1 – S10 include a first step S1, a second step S2, a third step S3, a fourth step S4, a fifth step S5, a sixth step S6, a seventh step S7, an eighth step S8, a ninth step S9, and a tenth step S10.

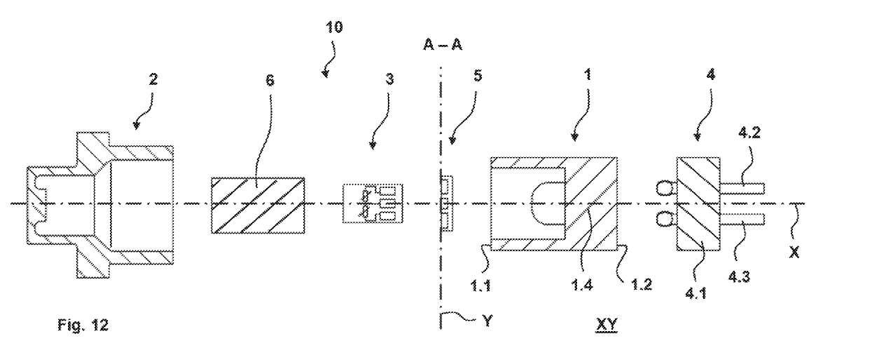

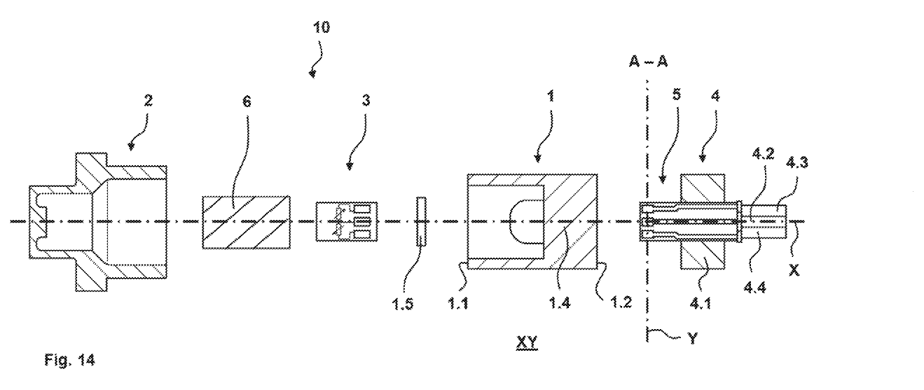

For the two embodiments of the sensor 10 as shown in FIGS. 1 to 4, in the first step S1, the inner housing part 1, the diaphragm element 2, the measuring unit 3, and the feedthrough 4 are provided and desirably aligned along the longitudinal axis X as shown in FIGS. 12 and 14.

For the two embodiments of the sensor 10 as shown in FIGS. 1 to 4, in the first step S1, preferably also the tapping unit 5 is provided and desirably aligned along the longitudinal axis X as shown in FIGS. 12 and 14.

For the two embodiments of the sensor 10 as shown in FIGS. 1 to 4, in the first step S1, preferably also the transmission element 6 is provided and desirably aligned along the longitudinal axis X as shown in FIGS. 12 and 14.

In the second embodiment of the sensor 10 as shown in FIGS. 2 and 4, in the first step S1, preferably the pin elements 4.2 – 4.5 of the feedthrough 4 are fastened to the fifth contacting sites 5.91 – 5.94 of the tapping unit 5 by means of the material-bonded connection. Furthermore, the tapping unit 5 is inserted into the axial opening 4.10 of the feedthrough body 4.1, and the contact body 5.1 of the tapping unit 5 is fastened within the axial through-hole 4.10 by means of the material-bonded connection.

For the two embodiments of the sensor 10 as shown in FIGS. 1 to 4, in the first step S1, preferably the feedthrough body 4.1 of the feedthrough 4 is placed onto the second housing end 1.2 of the inner housing part 1 and fastened to the housing wall 1.3 by means of the second material-bonded connection 4.7.

In the second embodiment of the sensor 10 as shown in FIGS. 2 and 4, in the first step S1, the tapping unit 5 that is fastened in the axial through-hole 4.10 of the feedthrough 4 is arranged in the cavity 0, preferably by securing the feedthrough body 4.1 of the feedthrough 4 to the housing wall 1.3.

For the two embodiments of the sensor 10 as shown in FIGS. 1 to 4, in the second step S2, the measuring unit 3 is inserted into the cavity 0 in the longitudinal direction X through the axial opening 1.11 at the first housing end 1.1.

In the first embodiment of the sensor 10 as shown in FIGS. 1 and 3, in the second step S2, preferably the tapping unit 5 and the measuring unit 3 are inserted into the cavity 0 in the longitudinal direction X through the axial opening 1.11 at the first housing end 1.1. When arranged within the cavity 0, one end of the tapping unit 5 rests against the support body 1.4 of the inner housing part 1 with one side, and the measuring unit 3 rests against the opposite end of the tapping unit 5.

In the second embodiment of the sensor 10 as shown in FIGS. 2 and 4, in the second step S2, preferably the insulator body 1.5 and the measuring unit 3 are inserted into the cavity 0 in the longitudinal direction X through the axial opening 1.11 at the first housing end 1.1. When positioned within cavity 0, one end of the insulator body 1.5 rests against the support body 1.4 of the inner housing part 1, and the measuring unit 3 rests against the opposite end of the insulator body 1.5.

For the two embodiments of the sensor 10 as shown in FIGS. 1 to 4, in the second step S2, preferably the measuring unit 3 and the transmission element 6 are inserted into the cavity 0 in the longitudinal direction X through the axial opening 1.11 at the first housing end 1.1.

In the first embodiment of the sensor 10 as shown in FIGS. 1 and 3, when the tapping unit 5 is arranged in the cavity 0, one of its ends rests against the support body 1.4, and the measuring unit 3 rests against the opposite end of the tapping unit 5, and one end of the transmission element 6 rests against the opposite side of the measuring unit 3.

In the second embodiment of the sensor 10 as shown in FIGS. 2 and 4, the introduction of the insulator body 1.5, the measuring unit 3 and the transmission element 6 into the cavity 0 is carried out in such a way that, when arranged in the cavity 0, one side of the insulator body 1.5 rests against the support body 1.4 of the inner housing part 1, the measuring unit 3 rests against the other side of the insulator body 1.5, and the transmission element 6 rests against the other side of the measuring unit 3.

For the two embodiments of the sensor 10 as shown in FIGS. 1 to 4, in the third step S3, the diaphragm element 2 is attached to the first housing end 1.1 of the inner housing part 1.

For the two embodiments of the sensor 10 as shown in FIGS. 1 to 4, in the third step S3, preferably the diaphragm element 2 is placed on the axial opening 1.11 of the first housing end 1.1, and the diaphragm wall 2.3 is secured to the housing wall 1.3 by the first material-bonded connection 2.4.

For the two embodiments of the sensor 10 as shown in FIGS. 1 to 4, in the fourth step S4, conductor elements 5.21 – 5.26, 5.61 – 5.64 are provided.

For the two embodiments of the sensor 10 as shown in FIGS. 1 to 4, in the fifth step S5, the measuring unit 3 is brought into electrical contact with the feedthrough 4 by means of the plurality of first conductor elements 5.21 – 5.26, and the plurality of second conductor elements 5.61 – 5.64.

For the two embodiments of the sensor 10 as shown in FIGS. 1 to 4, in the fifth step S5, preferably the two measuring circuits 3.2, 3.3 are electrically connected with the feedthrough 4 by means of the plurality of first conductor elements 5.21 – 5.26, and the plurality of second conductor elements 5.61 – 5.64.

For the two embodiments of the sensor 10 as shown in FIGS. 1 to 4, in the fifth step S5, preferably the measuring unit 3 is electrically connected with the feedthrough 4 through the radial openings 1.31, 1.32 by means of the plurality of first conductor elements 5.21 – 5.26, and the plurality of second conductor elements 5.61 – 5.64. These electrical connections desirably are made robotically from outside the inner housing wall 1.3 of the inner housing part 1.

For the two embodiments of the sensor 10 as shown in FIGS. 1 to 4, in the fifth step S5, the radial openings 1.31, 1.32 afford external access for a tool to pass through to fix an electrical contact of the first conductor elements 5.21 – 5.26 with the first contacting sites 3.23 – 3.25 on the first supporting surface 3.11 of the measuring unit 3 and with the second contacting sites 3.33 – 3.35 on the second supporting surface 3.12 of the measuring unit 3 as well as with the third contacting sites 5.31 – 5.33 on the first contact surface 5.11 of the tapping unit 5 and with the fourth contacting sites 5.41 – 5.43 on the second contact surface 5.12 of the tapping unit 5. These electrical contacts desirably are fixed with a tool wielded robotically from outside the inner housing wall 1.3 of the inner housing part 1.

In the first embodiment of the sensor 10 as shown in FIGS. 1 and 3, in the fifth step S5, preferably the fixing tool is inserted through the radial openings 1.31, 1.32 to establish an electrical contact of the second conductor elements 5.61 – 5.64 with the third contacting sites 5.31 – 5.33 on the first contact surface 5.11 of the tapping unit 5 and with the fourth contacting sites 5.41 – 5.43 on the second contact surface 5.12 of the tapping unit 5 as well as with the pin elements 4.2 – 4.5 of the feedthrough 4.

For the two embodiments of the sensor 10 as shown in FIGS. 1 to 4, in the sixth step S6, an outer housing part 7 is provided.

For the two embodiments of the sensor 10 as shown in FIGS. 1 to 4, in the seventh step S7, the outer housing part 7 is slid in the longitudinal direction X onto the inner housing part 1 in a telescoping manner. When slid onto the inner housing part 1, the outer housing part 7 closes up the radial openings 1.31, 1.32 of the housing wall 1.3 from being accessed from outside the outer housing part 7.

For the two embodiments of the sensor 10 as shown in FIGS. 1 to 4, in the seventh step S7, the outer housing part 7 is secured to the first housing end 1.1. Preferably, in the seventh step S7, as schematically shown in FIGS. 13 and 15, the outer housing part 7 is fastened to the housing wall 1.3 and to the diaphragm wall 2.3 by means of the third material-bonded connection 7.1.

For the two embodiments of the sensor 10 as shown in FIGS. 1 to 4, in the eighth step S8, a cable 8 is provided.

For the two embodiments of the sensor 10 as shown in FIGS. 1 to 4, in the ninth step S9, the third conductor elements 8.2 – 8.5 of the cable 8 are electrically connected to the pin elements 4.2 – 4.5 of the feedthrough 4.

For the two embodiments of the sensor 10 as shown in FIGS. 1 to 4, in the tenth step S10, the cable sheath 8.6 of the cable 8 is attached to the outer housing part 7.

### LIST OF REFERENCE SYMBOLS

0 cavity

1 inner housing part

1.1, 1.2 housing ends

1.11 axial opening

1.3 housing wall

1.31, 1.32 radial openings

1.4 support body

1.5 insulator body

2 diaphragm element

2.1 protrusion

2.2 joint

2.3 diaphragm wall

2.4 first material-bonded connection

3 measuring unit

3.1 supporting body

3.11, 3.12 supporting surfaces

3.2 first measuring circuit

3.21 alpha first electrical resistance element

3.22 beta first electrical resistance element

3.23 alpha first contacting site

3.24 beta first contacting site

3.25 gamma first contacting site

3.3 second measuring circuit

3.31 alpha second electrical resistance element

3.32 beta second electrical resistance element

3.33 alpha second contacting site

3.34 beta second contacting site

3.35 gamma second contacting site

4 feedthrough

4.1 feedthrough body

4.10 axial through-hole

4.2 first pin element

4.3 second pin element

4.4 third pin element

4.5 fourth pin element

4.21 alpha sixth contacting site

4.31 beta sixth contacting site

4.41 gamma sixth contacting site

4.51 delta sixth contacting site

4.6 insulating element

4.7 second material-bonded connection

5 tapping unit

5.1 contact body

5.10 recess

5.11 first contact surface

5.12 second contact surface

5.13 further surface

5.21 alpha first conductor element

5.22 beta first conductor element

5.23 gamma first conductor element

5.24 delta first conductor element

5.25 epsilon first conductor element

5.26 zeta first conductor element

5.31 alpha third contacting site

5.32 beta third contacting site

5.33 gamma third contacting site

5.41 alpha fourth contacting site

5.42 beta fourth contacting site

5.43 gamma fourth contacting site

5.52 alpha first electrical conductor path

5.53 beta first electrical conductor path

5.61 alpha second conductor element

5.62 beta second conductor element

5.63 gamma second conductor element

5.64 delta second conductor element

5.71 alpha second electrical conductor path

5.72 beta second electrical conductor path

5.73 gamma second electrical conductor path

5.81 alpha third electrical conductor path

5.82 beta third electrical conductor path

5.83 gamma third electrical conductor path

5.91 alpha fifth contacting site

5.92 beta fifth contacting site

5.93 gamma fifth contacting site

5.94 delta fifth contacting site

6 transmission element

7 outer housing part

7.1 third material-bonded connection

7.2 fourth material-bonded connection

8 cable

8.1 cable insulation

8.2 alpha third conductor element

8.3 beta third conductor element

8.4 gamma third conductor element

8.5 delta third conductor element

8.6 cable sheath

10 sensor

A – A section path

N1, N2 support surface normal

N1’, N2’ contact surface normal

P pressure

S1 – S10 steps

S+, S- measurement signal

U+, U- operating voltage

X, Y, Z axis

XY, XZ, YZ plane

What is claimed is:

1. A sensor for measuring a pressure, the sensor comprising:
an inner housing part that is hollow and defined by a cylindrical housing wall elongating along a longitudinal axis between a first housing end and a second housing end, wherein an inside of the housing wall encloses a cavity and an outside of the housing wall of the inner housing part is configured concentrically with respect to the inside, wherein an axial opening of the cavity is defined at the first housing end of the inner housing part;
a hollow cylindrical diaphragm element configured and disposed to conduct the pressure to be measured into the cavity, wherein the diaphragm element defines a closed end disposed spaced apart along the longitudinal axis from an open end that is attached to the first housing end and connects to the cavity via the axial opening;
a measuring unit disposed in the cavity and configured to operate according to the piezoresistive measuring principle and to generate at least one measuring signal under the effect of the introduced pressure;
a feedthrough attached to the inner housing part in a manner that closes up the cavity at the second housing end, wherein the feedthrough is configured and disposed to conduct the measuring signal from the cavity to the outside of the inner housing part;
a tapping unit that includes a solid cuboidal contact body made of electrically insulating material and defining a first contact surface disposed spaced apart from and parallel to a second contact surface, wherein the first contact surface defines a first contact surface normal and the second contact surface defines a second contact surface normal that is disposed at an angle greater than zero with respect to an angle of disposition of the first contact surface normal; and
a plurality of conductor elements that are configured and disposed to electrically connect the measuring unit to the feedthrough via the first contact surface and the second contact surface.

2. The sensor according to claim 1, wherein the housing wall defines a first radial opening and a second radial opening, wherein the first radial opening is configured and disposed so that the first contact surface normal passes through the first radial opening at a right angle in a radial direction from the longitudinal axis, and wherein the second radial opening is configured and disposed so that the second contact surface normal passes through the second radial opening at a right angle in the radial direction from the longitudinal axis.

3. The sensor according to claim 2, wherein the measuring unit includes a supporting body, a first measuring circuit and a second measuring circuit;
the supporting body defines a first supporting surface and a second supporting surface, wherein the first supporting surface supports the first measuring circuit and the second supporting surface supports the second measuring circuit;
wherein the first supporting surface defines a first supporting surface normal and the second supporting surface defines a second supporting surface normal; and
wherein the first supporting surface normal passes through the first radial opening at a right angle in the radial direction and the second supporting surface normal passes through the second radial opening at a right angle in the radial direction.

4. The sensor according to claim 3, wherein the supporting body is made of electrically insulating material;
wherein the first measuring circuit includes a plurality of first contacting sites made of electrically conductive material;
wherein the second measuring circuit includes a plurality of second contacting sites made of electrically conductive material;
wherein the first and second measuring circuits are electrically connected to form a Wheatstone bridge circuit such that when an operating voltage is applied to at least two of the plurality of first contacting sites and at least two of the plurality of second contacting sites, then the pressure applied to the Wheatstone bridge circuit causes a change in resistance that is detected by at least one of the plurality of first contacting sites and by at least one of the plurality of second contacting sites.

5. The sensor according to claim 4, wherein each of the first and second supporting surfaces extends parallel to the longitudinal axis in a transverse plane;
wherein each of the plurality of first contacting sites on the first supporting surface is accessible from the outside the inner housing part through the first radial opening in the radial direction; and
wherein each of the plurality of second contacting sites on the second supporting surface is accessible from the outside the inner housing part in the radial direction through the second radial opening.

6. The sensor according to claim 4, wherein the tapping unit includes a plurality of third contacting sites made of electrically conductive material and a plurality of fourth contacting sites made of electrically conductive material;
wherein the first contact surface carries the plurality of third contacting sites; and
wherein the second contact surface carries the plurality of fourth contacting sites.

7. The sensor according to claim 6, wherein the tapping unit includes a plurality of first electrical conductor paths made of electrically conductive material;
wherein the contact body defines a further surface that adjoins the first and second contact surfaces;
wherein the further surface carries the plurality of first electrical conductor paths; and
the first electrical conductor paths electrically connect the plurality of third contact sites of the first contact surface to the plurality of fourth contact sites of the second contact surface.

8. The sensor according to claim 6, wherein the feedthrough includes a plurality of pin elements made of electrically conductive material;
wherein the tapping unit includes a plurality of fifth contacting sites made of electrically conductive material;
wherein the contact body defines a further contact surface that adjoins the first and second contact surfaces, wherein the further contact surface carries the plurality of fifth contacting sites, which are electrically connected to the pin elements.

9. The sensor according to claim 8, wherein the tapping unit includes a plurality of second electrical conductor paths made of electrically conductive material and a plurality of third electrical conductor paths made of electrically conductive material;
wherein the first contacting surface and the further contact surface carry the plurality of second electrical conductor paths;
wherein the second contacting surface and the further contact surface carry the plurality of third electrical conductor paths;
wherein the plurality of second electrical conductor paths electrically connect the plurality of third contacting sites of the first contact surface with the plurality of fifth contacting sites of the further contact surface; and
wherein the plurality of third electrical conductor paths electrically connect the plurality of fourth contacting sites of the second contact surface with the plurality of fifth contacting sites of the further contact surface.

10. The sensor according to claim 6, wherein the contact body defines a recess that is cut along the longitudinal axis between the plurality of third contacting sites of the first contact surface and the plurality of fourth contacting sites of the second contact surface; and
wherein the recess is configured to prevent the force flow of the pressure to be measured from reaching the contact body.

11. The sensor according to claim 6, wherein each of the first and second contact surfaces extends parallel to the longitudinal axis in a transverse plane;
wherein each of the plurality of third contacting sites on the first contact surface is accessible from the outside of the inner housing part through the first radial opening in the radial direction; and
wherein each of the plurality of fourth contacting sites on the second contact surface is accessible from the outside of the inner housing part in the radial direction through the second radial opening.

12. The sensor according to claim 6, wherein the plurality of conductor elements includes a plurality of first conductor elements made of electrically conductive material, which plurality of first conductor elements establishes an electrical contact between the plurality of first contacting sites and the plurality of second contacting sites with the plurality of third contacting sites and the plurality of fourth contacting sites.

13. The sensor according to claim 12, wherein the feedthrough includes a plurality of pin elements made of electrically conductive material;
wherein the plurality of conductor elements includes a plurality of second conductor elements made of electrically conductive material, which second conductor elements establish an electrical contact between the plurality of third contacting sites and the plurality of fourth contacting sites with the plurality of pin elements.

14. The sensor according to claim 1, further comprising an outer housing part that sufficiently overlays the inner housing part in longitudinal direction to cover up the radial openings of the housing wall of the inner housing part.

15. A process for manufacturing a sensor for measuring a pressure, the process comprising the steps of:
providing an inner housing part, a diaphragm element, a measuring unit, a feedthrough, a plurality of conductor elements made of electrically conductive material, and a tapping unit, wherein the tapping unit includes a solid cuboidal contact body made of electrically insulating material and defining a first contact surface disposed spaced apart from and parallel to a second contact surface, wherein the first contact surface defines a first contact surface normal and the second contact surface defines a second contact surface normal that is disposed at an angle greater than zero with respect to an angle of disposition of the first contact surface normal;
moving the measuring unit in a longitudinal direction through an axial opening at a first housing end of the inner housing part and into a cavity defined within the inner housing part;
moving the tapping unit in the longitudinal direction through the axial opening at the first housing end of the inner housing part and into the cavity defined within the inner housing part;
attaching the diaphragm to the first housing end of the inner housing part to close off the cavit at the first housing end of the inner housing part; and
electrically connecting the measuring unit to the feedthrough via the the plurality of conductor elements of the tapping unit and the first and second contact surfaces of the tapping unit.
